(19) United States
(12) Patent Application Publication
(10) Pub. No.: US 2014/0019339 A1
(43) Pub. Date: Jan. 16, 2014

(54) COMMUNICATION PROTOCOL FOR ELECTRONIC FUNDS TRANSFER SYSTEMS

(71) Applicant: Hyperwallet Systems, Inc., (US)

(72) Inventors: LISA SHIELDS, VANCOUVER (CA); BLAIR OLYNYK, VANCOUVER (CA); WILLIAM CROWLEY, VANCOUVER (CA)

(73) Assignee: HYPERWALLET SYSTEMS, INC., Vancouver (CA)

(21) Appl. No.: 13/725,500

(22) Filed: Dec. 21, 2012

Related U.S. Application Data
(60) Provisional application No. 61/578,513, filed on Dec. 21, 2011.

(51) Int. Cl. G06Q 20/02

(52) U.S. Cl. CPC G06Q 20/023
USPC 705/39

(57) ABSTRACT

A method and system for the electronic transfer of funds utilizes a computerized facilitating agent and associated database which contains the addresses and operating protocols of all known accounts. A sender of funds instructs the facilitating agent as to the recipient and recipient's destination account and the amount to be transferred. Using the database, the facilitating agent can acquire the address of the recipient destination account and the protocols required for a transfer and effectuates the transfer utilizing available automated clearing house procedures without human intervention.

### BACKGROUND OF THE INVENTION

1. Field of the Invention

The invention relates to electronic transactions and payments in particular. More particularly, the present invention is in the technical field of online payments connecting bank accounts and other payment networks.

2. General Background and State of the Art

For many years, international funds transactions were accomplished with special facilities under the aegis of the Society for Worldwide Interbank Telecommunications (“SWIFT”) which required dedicated circuits and special addresses. Domestic transactions were done under a system know as the Federal Reserve Wire Network (“FEDWIRE”) or through other localized clearing and settlement systems.

The Internet has enabled a variety of electronic funds transfer methods, including the PayPal® electronic payment processing system and other online payment systems. Most nations have Settlement and Clearing Systems with which transfers are effectuated. In the United States, the system is known as the Automated Clearing House system (“ACH”). A deficiency in each of these methods is that the sender commits to sending the funds before the recipient receives notice of the proposed transaction. A number of countries have adopted anti-money laundering (“AML”) legislation which requires the verification of the party providing instructions for a funds transfer, and this legislation may be interpreted to require the provider of a payment system to verify the identity of the recipient of the funds transfer, and not only the sender. What is needed is a system that will be compliant and compatible with anti-money laundering goals and any legislation adopted to control that practice.

### INVENTION SUMMARY

The invention provides a means for a person to receive funds electronically without having to be a member of the system responsible for transferring the funds or being a member of the same system as the person sending the funds. Further, the SWIFT system need not be utilized for international transactions. The invention's messaging system (i) provides the sender with an opportunity to confirm the transaction after the recipient has accepted the transfer, but before funds are delivered to the recipient, and (ii) establishes a clear line of communication between the sender and the system which clearly removes any obligation of the system to verify the identity of the recipient under proposed or existing AML legislation.

The invention consists of a configurable set of communication protocols that the system can use to interact as a messaging intermediary between the sender and the recipient of a funds transfer using SWIFT, FEDWIRE, the ACH system or its foreign counterparts. The system must contain the following information for each transaction: recipient identifier, destination type and destination type identifier. Examples of communication methods include, but are not limited to, email, phone and SMS text messaging.

The recipient identifier uniquely identifies the recipient of the funds transfer, where the format pattern and universal validity are tied directly to the communication method. As an example, the phone number communication method is constrained by the E.164 format.

The destination type is a currency sink, such as a bank. Other types of stored value or e-money accounts can serve as the destination type as well. The destination type identifier is a tuple of information that uniquely identifies the destination account type to which the funds are supposed to be transferred. For a bank account, the account number would be the destination type identifier, and corresponding identifiers could be used for other forms of accounts.

The funds amount is a denomination value equal to the amount of currency being transferred. The format of the funds amount is directly tied to the currency code for which the transaction will occur. Within the system a currency code follows the ISO 4217 three character numeric code, but is visually represented by the ISO 4217 three character alpha code.

The source type is the origin account of the funds that will be transferred to the recipient upon completion of the sender/recipient/system interaction. The source type is analogous to the destination type within the system, the primary difference being the fact that it is the origin, not the destination of the funds. Source type and destination type sets do not have to be equivalent.

The source type identifier is a tuple of information that uniquely identifies the account from which the funds are to be transferred. For a bank account, the account number would be a sender type identifier.

The system must be able to authenticate the sender of funds. Each sender must be known to the system as a principal, verifiable through an authentication mechanism. The sender must have access to funds either within the system or through an external source connected to the system such that the funds are available in real time. Funds available in real time are considered to be safe; an example of this would be a credit card authorization and capture. In one embodiment, the facilitating agent, which oversees the entire operation, may require that funds be remitted to it before initiating any funds transfers.

A transaction can expire. The expiration date will be a configurable value. From its start date to its expiration date, a funds transfer transaction must be available for completion or cancellation.

The recipient of a funds transfer is not required to be a member of the system, though it may be. If it is a member of the system, the transaction occurs in the same manner as a recipient who is not a member of the system.

The set of destination and source types of the transaction do not have to be equivalent. The funds may originate from a different source type than the destination type for which they will be transferred; for example, funds may originate with a credit card source and be deposited to a bank account as the destination.

The currency code of the sender's funds source type does not have to be the same currency code of the recipient's destination type. In the event of a currency code mismatch, the sender will be presented with the foreign exchange details before the transaction is processed by the system.

A transaction must contain all of the following fact types to be processed: communication type, recipient identifier, sender identifier, funds amount, currency code, destination type, destination identifier, source type and source identifier. When the facilitating agent is in possession of the funds, the sender identifier may be the facilitating agent.

There are three stages to any transaction. The first stage is used to gather the fact types that are known to the sender, including communication type, recipient identifier, sender identifier, funds amount, currency code, source type, and source type identifier. In the second stage, the recipient provides the destination type and destination identifier. In the third and final stage, the transaction is processed by the system (the actual transfer of funds).

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWING

FIG. 1 is a block diagram of the steps of a typical transaction;

FIG. 2 is a summary of the components required to operate the system;

FIG. 3 illustrates the steps of a sender in a typical transaction;

FIG. 4 illustrates the steps of a recipient in a typical transaction; and

FIG. 5 illustrates the steps at the completion of a typical transaction; and

FIG. 6 illustrates typical equipment useful in the present invention.

### DETAILED DESCRIPTION OF THE DRAWING

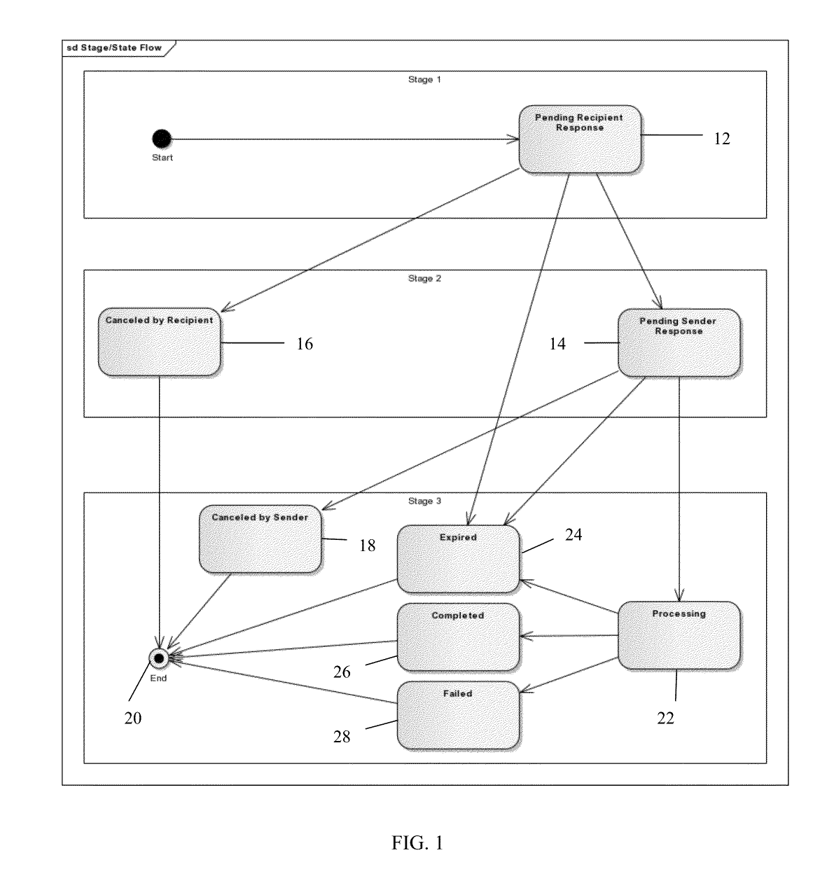

Referring to the invention in more detail, in FIG. 1 there is shown a block diagram summary of the stages of a typical transaction 10. Starting with Stage 1, the process includes the Collect Sender data step 12: This state begins once all of the required sender fact types have been determined such as communication type, recipient identifier, sender identifier, funds amount, currency code, source type, and source type identifier. Next, the Recipient data collection step 14 begins by assembling all of the required recipient facts such as destination type and destination identifier.

A cancelation of the transaction by the Recipient step 16 is available when the recipient refuses to accept the funds transfer and the process terminates. A cancellation by the Sender step 18 can be used by the sender rejecting the funds transfer. These steps lead to the Transaction End 20.

Processing step 22 begins when the sender accepts the proposed funds transfer. The transaction can end in one of three steps. There is the Failure step 24 when a transaction in process is unable to be completed. The process also ends, preferably with the Completed step 26 which is attained when a transaction has been processed and the funds have moved from the sender to the recipient. The transaction also has a Transaction Expired step 28 which is reached when the transactions start date plus the number of days a transaction can be kept alive exceeds the current date. This step is applicable to any transaction which has not already reached a terminal state.

In stage two of FIG. 1, the recipient's interactions with the system do not require any authentication because the recipient is not a principal within the system. For the purposes of this embodiment of the invention, the recipient is simply a guest. Accordingly, the recipient is provided with an obfuscated identification reference that is used to link the destination type and destination type identifier with the transaction. The identification reference must be sufficiently complex such that it is not easily determinable by anyone with knowledge of the system, the sender or the recipient.

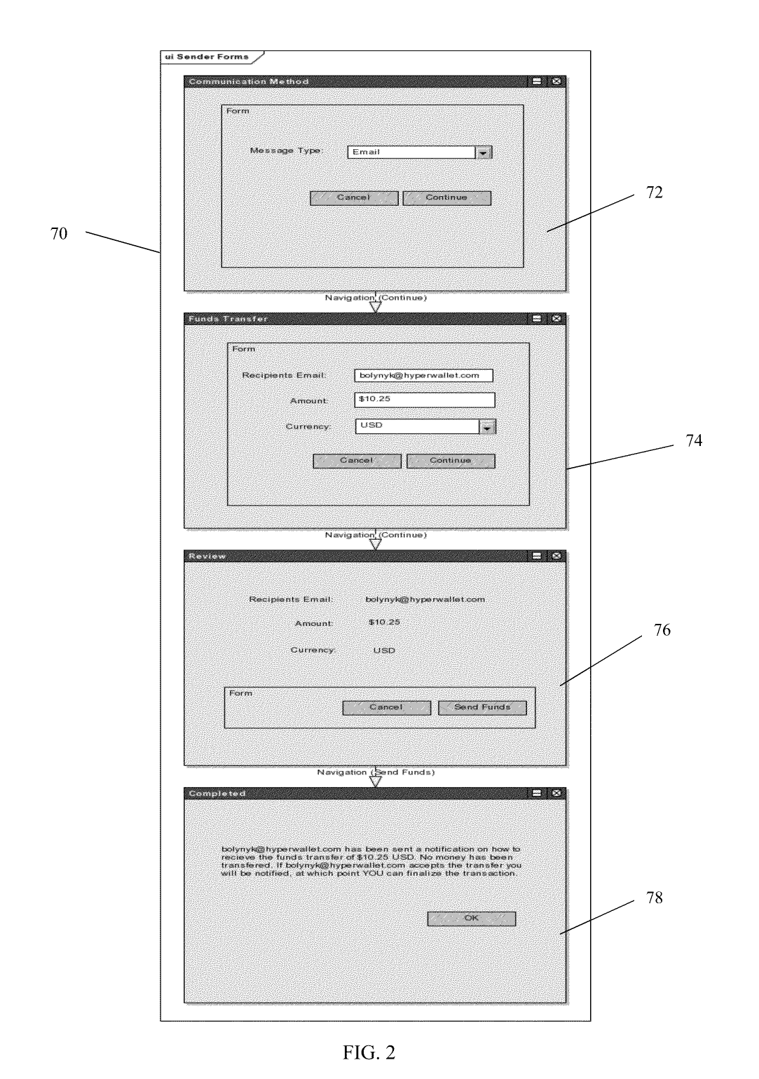

Turning next to FIG. 2, there is shown as a succession of screen shots, the displaying the details of a transaction from the sender's perspective. While the specification describes particular embodiments of the present invention, those of ordinary skill can devise variations of the present invention without departing from the inventive concept.

Initially, an sender logs into a system and, after the system validates the sender's credentials to determine authenticity, if the sender is known to the system and is allowed to access secure functionality, a Communication Method interface 72, used to gather the required information, is presented to the sender. The sender selects the desired communication method and provides the unique identifier of the recipient for the communication method selected.

At a Funds Transfer interface 74, the recipient is identified and validated. The amount of money to be transmitted to the recipient is entered and validated. The sender provides the currency code of the funds being transferred. The currency code of the funds to be transferred is validated and the sender's identifier for the communication method selected, along with the transfer amount, currency code, and recipient identifier for the communication method selected are all formatted into a message.

The message is presented to the sender for review in Review Screen 76; the sender is then allowed to cancel or send the message to the recipient. If acceptable, the message is sent to the recipient through the system and the sender is notified that the message has been sent to the recipient with a Completed screen 78.

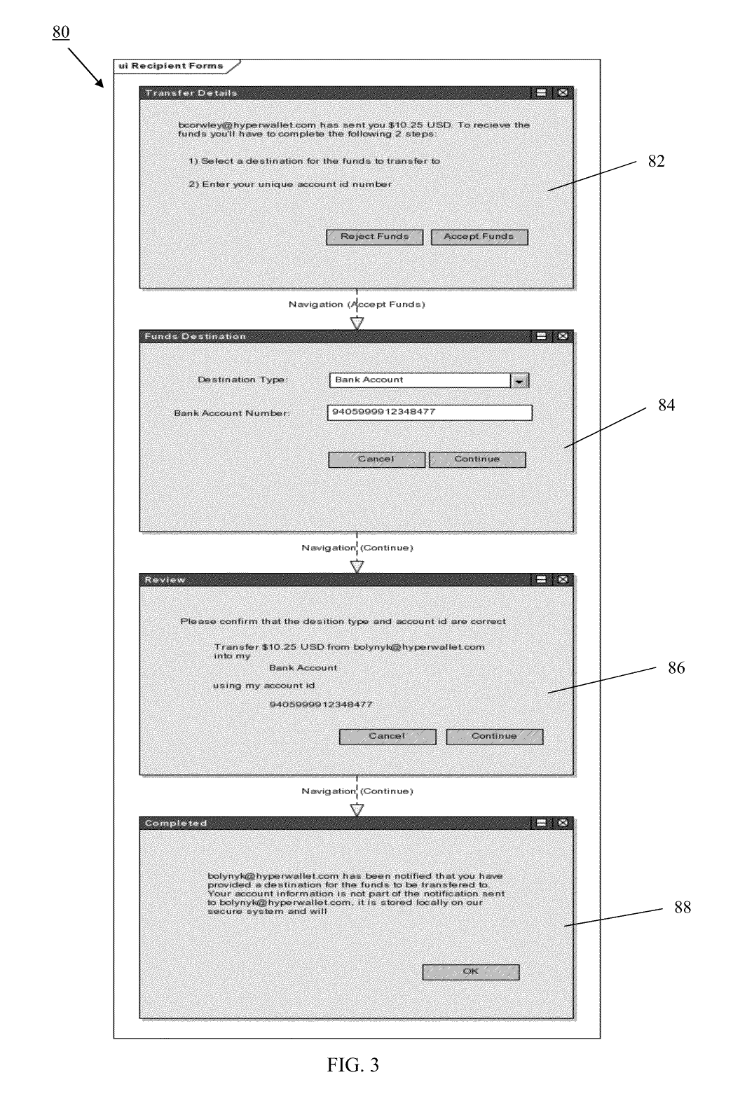

FIG. 3 shows a series of screens 80 at the recipient's end of the transaction. In a Details screen 82, The recipient receives a message setting out the availability of funds and instructions on how to acquire the funds. The recipient uses the details screen 82 to view the formatted message from the sender. A choice must be made by the recipient to proceed with the transfer of the funds or to cancel the transaction.

If the transaction is to proceed, the recipient must select a destination account to which the funds are to be moved. A Funds Destination interface 84 allows the selection of the destination account to which the funds will be remitted. The recipient must submit a unique identifier such as a password using Review interface 86. Validation of the identifier for the specified destination account is required, and, if validated, the transaction may proceed. A Completed screen 88 provides a message that confirms the details of the transaction.

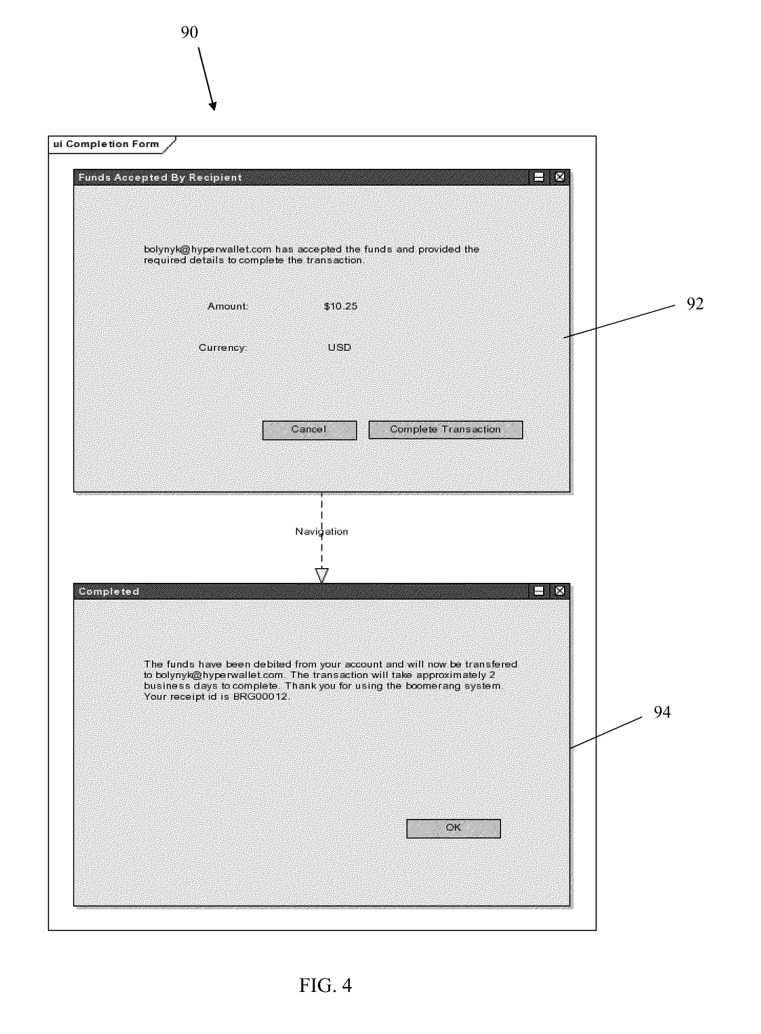

Turning next to FIG. 4, a pair of “transaction completion” interfaces 90 are illustrated. A Funds Accepted interface 92 is provided to the sender of the funds when the recipient has satisfied all of the requirements for a transfer. The sender is also provided with a Completed interface 94 containing the details of the transfer of funds to the recipient which can be printed as a receipt for the transaction.

In operation, using the user-provided authentication credentials, the authenticator 64 interacts with the account manager 62 to retrieve the sender's account information. The transaction engine 56 uses the external account entity 58 to retrieve the financial account information for a destination/source type that is not maintained by the system. The communicator 54 interacts with the other communication providers 66 to receive and send messages.

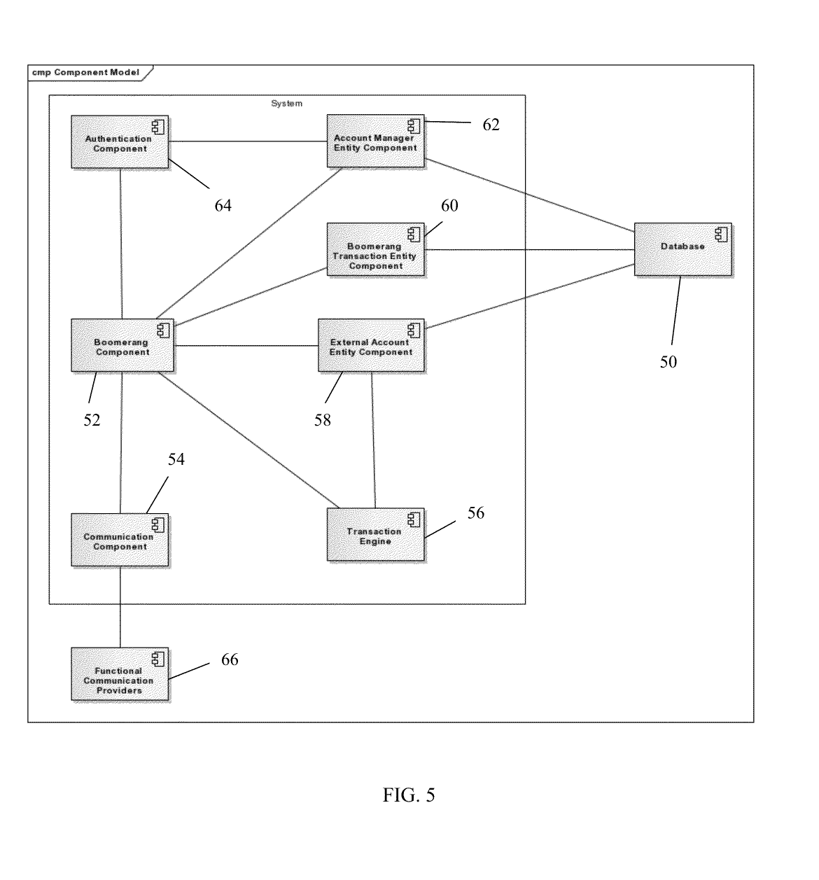

Turning next to FIG. 5, there is shown a summary of the invention's components and their interactions. Key to the entire operation is a database 50 which may be a collection of external databases. A system controller 52 provides all functional handling of the transaction, and interacts with a communicator 54 to send a message to a recipient or sender. It also will handle any incoming messages from a recipient or sender and will process the message in accordance with the system's business processes;

A transaction engine 56 handles the journalization of all financial transactions within the system, and will interact with the controller 52 when all of the requisite transaction information has been gathered from the sender and recipient. The controller 52 will use the transaction engine 56 to journalize the financial transaction within the system and marshal the funds for transfer;

An external account device 58 handles the ‘Create, Read, Update and Delete’ (“C.R.U.D.”) functionality for external accounts data, and retrieves the set of external accounts that may be used as a source type from the database 50. A transaction engine 60 handles the C.R.U.D. functionality for the primary transaction and persists the state of the long running transaction. An account manager 62 handles the C.R.U.D. functionality for accounts data, including the creation of a new recipient within the system, or if one exists, retrieves the details of that recipient from the database 50.

An authentication device 64 validates the sender as a principal of the system, and interacts with the controller 52 in a transparent manner so that the sender must be authenticated and have the correct permissions to access the functionality of the controller 52.

The communicator 54 is responsible for processing all incoming and outgoing messages and maintaining the system configurations for all communication functions. Functional communication providers 66 handle incoming/outgoing messages from external clients and route them to the correct system. Each of the functional communication providers 66 guarantees the unique identifier mappings for its communication protocol.

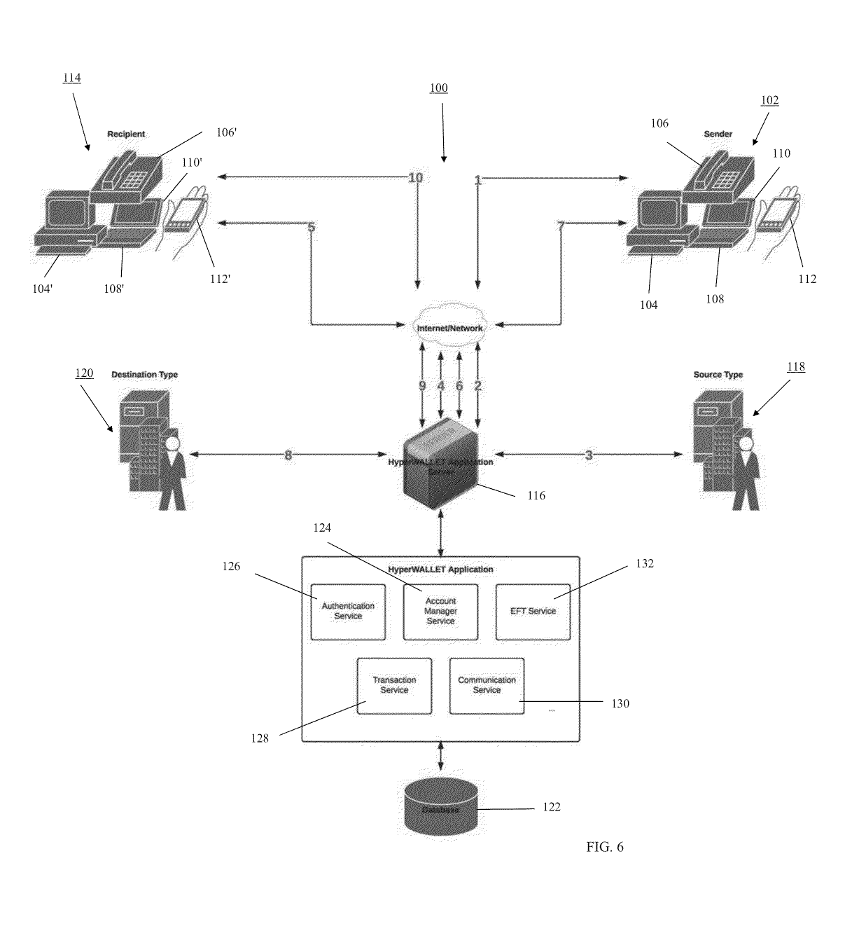

Turning finally to FIG. 6, there are shown typical hardware elements with which to operate a system 100 that practices the invention. For a sender 102, a plurality of devices are shown, including, but not limited to a desk top computer 104, a telephone 106, a laptop computer 108, a tablet 110, or a handheld device 112 which could be a smart phone or other personal digital assistant.

A recipient 114 can have the same or similar hardware including, but not limited to a desk top computer 104′, a telephone 106′, a laptop computer 108′, a tablet 110′, or a handheld device 112′. Using the internet or other communication modalities, both the sender 102 and the recipient 114 are in contact with a facilitating agent 116 which, in turn, communicates with an institution maintaining the sender's account 118 and an institution maintaining the recipient's destination account 120. A database 122 contains all the information necessary to allow the facilitating agent 116 to communicate with the institution maintaining the sender's destination account 118 and the institution maintaining the recipient's destination account 120.

Within the facilitating agent 116 are a plurality of service modules including an account manager service 124 an authentication service 126, a transaction service 128, a communications service 130 and an Electronic Funds Transfer (“EFT”) service 132. With these service modules, the facilitating agent 116 can receive instructions from a sender 102, and authenticate the identity of the sender 102. The communication providers permit the sender 102 to contact a recipient 114 with the details of a proposed transfer and utilize the response of the recipient 114 to advise the facilitating agent 116 to retrieve from the database 122 the information necessary to identify the receiving destination account 120. From the sender, sufficient information is provided so that the database 122 can identify the sender's source of funds 118.

When the recipient 114 has accepted the proposed transfer, the sender 102 then authorizes a funds transfer and, armed with the knowledge of the sending and receiving accounts, the amount to be transferred and the accounts to be debited and credited, the facilitating agent 116 can then initiate an EFT and advise the sender 102 and recipient) 14 of the successful transfer of funds. This transfer can be effectuated between any financial accounts, whether foreign or domestic without the need for conventional interbank transfer protocols.

The advantages of the present invention for the sender before the recipient accepts the funds transfer include, without limitation:
1. The sender is known to the system and is allowed to access secure functionality;
2. The sender selects the desired communication method to interact with the recipient;
3. The sender provides the unique identifier of the recipient for the communication method selected;
4. The sender provides the currency code of the funds being transferred;
5. The sender's identifier for the communication method selected, along with the transfer amount, currency code, and recipient identifier for the communication method selected are formatted into a message;
6. The message is presented to the sender for review, the sender is allowed to cancel or send the message to the recipient;
7. The message is sent to the recipient (through the system); and
8. The sender is notified that the message has been sent to the recipient.

Additional advantages of the present invention for the sender after the recipient accepts the funds transfer include, without limitation:
1. The sender receives a message confirming that the recipient has provided the necessary information to complete a funds transfer;
2. The sender is presented with a final summary of all of the transaction details (save for those provided by the recipient that are considered confidential);
3. The sender must choose whether to finalize the funds transfer or cancel the transaction; and
4. If approved, the transaction is marked for processing and the details are submitted to the system to complete the transaction on the sender's behalf.

The advantages of the present invention for the recipient include, without limitation:
1. The recipient receives a message setting out the availability of funds and instructions on how to acquire the funds;
2. The recipient uses the interface provided to view the formatted message from the sender;
3. A choice must be made by the recipient to proceed with the acquisition of the funds or to terminate the transaction;
4. The recipient must select a destination account into which the funds are to be moved;
5. A unique identifier that belongs to the recipient for the destination account specified must be submitted by the recipient;
6. Validation of the identifier for the specified destination account;
7. The recipient's identifier for the specified destination account is formatted into a protocol appropriate message;
8. The message is presented to the recipient to review via the interface being used and the recipient is allowed to cancel or send the message for processing; and
9. The message is sent to the system for processing.

Thus there has been disclosed an electronic funds transfer system and, in a preferred embodiment, the steps of the operation. Minor modifications can be made within the scope of the invention.

What is claimed is:

1. A system for converting internationally initiated banking messages into domestic banking transactions comprising:
(a) a central computer system;
(b) at least one terminal adapted to receive banking messages;
(c) first communications means for exchanging transmitting information between said terminal and said central computer system;
(d) second communication means for receiving information from more than one of said terminals; and
(e) look up means coupled between said central computer system and one or more external databases for converting messaging codes from one banking system into corresponding codes from different banking systems to enable a transfer of funds among accounts including overseas funds accounts and domestic funds accounts;
whereby funds can be transferred between a domestic destination account and both domestic and international accounts.

2. The system of claim 1 wherein SWIFT message data is compared to data in a database containing a comprehensive listing of financial institution locations worldwide and payment processing data providing, among other things, the correct codes to use when enacting a payment message to a network within the group including an ACH network, a similar national authorization network and a regional authorization network.
The system of claim 1, wherein the electronic funds transfer is a credit through a member of the network group including an ACH network, similar national authorization networks and regional authorization networks, in each case replacing a SWIFT wire transaction.

3. The system of claim 1, wherein said lookup means converts SWIFT message data to a credit through a network of a group including an ACH network, a similar national authorization network and a regional authorization network, without requiring human intervention.

4. The system of claim 1, wherein the electronic communication preferences of both the ultimate payment sender and ultimate payment beneficiary are collected and utilized to provide payment clearing status transparency and payment instruction correction without requiring human intervention.

5. A method for converting internationally initiated banking messages into domestic banking transactions comprising the steps of:
(a) receiving a banking instruction to transfer funds;
(b) looking up account information for the sender of funds;
(c) looking up account information for the recipient of funds; and
(d) converting messaging codes from the banking method of the sender into corresponding codes from the banking methods of the recipient;
(e) receiving an authorization from the sender to proceed;
(f) transmitting a message to the institution maintaining the sender's funding account to debit funds:
(g) transmitting a message to an institution maintaining the recipient's destination account to credit funds;
whereby a transfer of funds can be effected between accounts and institutions with different transfer protocols whereby a SWIFT messaging code can be converted into a messaging code recognizable to a network from the group including an ACH network, a similar national authorization network and a regional authorization network without requiring human intervention.

6. The method of claim 6 wherein one of the transfer protocols is the SWIFT and another protocol is the ACH and stored data includes a comprehensive listing of financial destination account locations worldwide and payment processing data providing correct codes to use when transferring funds between accounts and institutions with different protocols, including the further step of retrieving the appropriate codes to communicate the transaction to the institution maintaining the recipient's destination account.

7. The method of claim 6, wherein the electronic funds transfer is a credit through a network of a group including the ACH network, a national authorization network and a regional authorization network, and including the further step of replacing a SWIFT wire transaction with a protocol appropriate to the selected network.

8. The method of claim 6, wherein the step of converting includes converting a sender's SWIFT message code to a message code compatible with the institution maintaining the recipient's destination account through a network of a group including an ACH network, a similar national authorization network and a regional authorization network, and which provides a message which, when sent, is sufficient to create a credit in the receiving destination account without requiring human intervention.

9. The method of claim 6, including the further step of collecting and utilizing the electronic communication preferences of both the ultimate payment sender and ultimate payment receiver to provide payment clearing status transparency and payment instruction without human intervention.

10. A method of effectuating funds transfers as between a sender and a recipient's account comprising the steps of:
(a) Contacting a facilitating agent by a potential sender;
(b) Identifying to the facilitating agent the potential recipient;
(c) Maintaining a data base of addresses of institutions from which funds can be withdrawn and into which funds can be deposited;
(d) Having the potential sender notify the potential recipient of the proposed transaction and soliciting destination account account details;
(e) Retrieving from the database the address of the destination account of the potential recipient of funds by the facilitating agent;
(f) Having the facilitating agent initiate a transfer process upon authorization by the potential sender; and
(g) Having the facilitating agent instruct the institution maintaining the potential recipient's destination account as to the account to be credited and the amount;
(h) Whereby the facilitating agent enables the transfer of sender's funds into a recipient's destination account.

11. The method of claim 11, further including the steps of:
(a) Retrieving from the database the address of the potential source of funds by the facilitating agent; and
(b) Having the facilitating agent instruct the source of funds as to the account to be debited and the amount.

12. The method of claim 11, further including the steps of:
(a) Transferring funds sufficient to cover the proposed transfer from the sender, to the facilitating agent; and
(b) transferring funds from the facilitating agent to the recipient's destination account; whereby the facilitating agent transfers sender's funds.

13. The method of claim 11, further including the steps of:
(a) establishing a deadline for the completion of the proposed transaction;
(b) cancelling the transaction after passage of the deadline if the transaction is not completed whereby a transaction can be time limited and cancelled if not completed within the allotted time.

14. The method of claim 11, further including the steps of:
(a) transmission of prospective sender's funding account information to the facilitating agent; and
(b) sending debiting instructions from the facilitating agent to sender's funding account utilizing a local automated clearing house or a similar system.

15. A method for converting internationally initiated banking messages into domestic banking transactions comprising the steps of:
(a) receiving a banking instruction to transfer funds;
(b) looking up account information for the sender of funds;
(c) looking up account information for the recipient of funds; and
(d) converting messaging codes from the banking methods of the sender into corresponding codes from the banking methods of the recipient;
(e) receiving an authorization from the sender to proceed;
(f) transmitting a message to the sender's funding account to debit funds: and
(g) transmitting a message to the recipient's destination account to credit funds;
whereby a transfer of funds can be effected between accounts and institutions with different transfer protocols.

16. The method of claim 15 wherein one of the transfer protocols is the SWIFT and another protocol is the ACH and stored data includes a comprehensive listing of financial account locations worldwide and payment processing data providing correct codes to use when transferring funds between accounts and institutions with different protocols, including the further step of retrieving the appropriate codes to communicate the transaction to the sender's and receiver's financial institutions.

17. The method of claim 15, wherein an electronic funds transfer is a credit through a network group including the ACH network, a national authorization network and a regional authorization network, and including the further step of replacing a SWIFT wire transaction protocol with a protocol appropriate to the selected network group.

18. The method of claim 15, wherein the step of converting the message code compatible with the payment instructions provided by the sender to a message code compatible with the receiver's financial institution to credit the remitted amount in the receiver's destination account without human intervention.

19. The method of claim 15, including the further step of collecting and utilizing the electronic communication preferences of both the ultimate payment sender and ultimate payment receiver to provide payment clearing status transparency and payment instruction correction without human intervention.

20. A system for effectuating funds transfers comprising:
(a) Facilitating means including a computer;
(b) Database means for storing destination account address data; and
(c) Communication means connected to said facilitating means for exchanging information among potential senders, potential recipients, potential debiting institutions and potential crediting institutions; whereby said facilitating means receives instructions from potential senders for proposed funds transfers from specified sender's account, instructions from potential recipients designating receiver's accounts, and, upon confirmation for the transaction from a potential sender, acquires address information of accounts to be debited and credited and supplies the appropriate financial institutions with sender and recipient account information and the amount to be transferred so that a funds transfer can be effectuated.
